(19) United States
(12) Patent Application Publication
(10) Pub. No.: US 2026/0249989 A1
(43) Pub. Date: Aug. 27, 2026

(54) Advanced V/STOL Aircraft with Lip-Wing Blended Body Configuration

(71) Applicant: Dusan Milivoi Stan, Stoney Creek (CA)

(72) Inventor: Dusan Milivoi Stan, Stoney Creek (CA)

(21) Appl. No.: 19/062,857

(22) Filed: Feb. 25, 2025

(51) Int. Cl. B64C 29/00; B64C 1/26; B64C 3/38

(52) U.S. Cl. CPC B64C 29/0033; B64C 1/26; B64C 3/38

(57) ABSTRACT

The present invention introduces a vertical/short takeoff and landing (V/STOL) aircraft with a lip-wing blended body configuration, enhancing aerodynamic performance, control, stability, and redundancy. A key innovation is the blended-lip-wing, which enhances aerodynamic surfaces for improved lift and efficiency during hover, transition, and enabling optimized thrust-providing devices for wing-borne level flight. A coupling mechanism adjusts the thrust-providing devices, positioning its inflow region adjacent to the blended-lip-wing, optimizing hover lift and flight transition. The thrust-providing devices are mounted on aerodynamically shaped support structures that also function as control surfaces, integrating vectored thrust for simplified control, enhancing maneuverability, authority, and redundancy. A sophisticated control system dynamically adjusts thrust and aerodynamic controls for stability, maneuverability, and redundancy. This aircraft achieves a unique balance of hover efficiency, cruise performance, and flight stability, making it ideal for military, commercial, and emergency applications.

### FIELD OF THE INVENTION

The present invention relates to vertical and short takeoff and landing (V/STOL) aircraft, specifically those utilizing a lip-wing and blended wing-body configuration. The invention is designed to enhance the aerodynamic performance, efficiency, and control of the aircraft throughout various flight phases. Moreover, it pertains to V/STOL aircraft incorporating thrust-providing devices with adjustable positioning mechanisms, commonly known as tilt-rotors. In addition, the invention focuses on augmenting lift and control by integrating adjacent aerodynamic surfaces into the thrust inflow region, thereby optimizing airflow, improving stability, and enhancing overall performance. Furthermore, the invention integrates vectored thrust and conventional aerodynamic control mechanisms into a unified system, simplifying control and improving flight capabilities.

### BACKGROUND OF THE INVENTION

Vertical takeoff and landing (VTOL) aircraft have long been sought after for their ability to operate in confined spaces while maintaining both vertical and horizontal flight efficiency. These capabilities make VTOL aircraft invaluable in various fields, including military, commercial, and emergency response operations. However, traditional VTOL designs face significant challenges related to efficiency, weight, stability, and control, particularly during hover and low-speed flight. Additionally, they often suffer from poor lift-to-drag ratios (L/D), and propulsion inefficiencies in wing-borne flight, which results in poor performance during cruise.

Helicopters are widely recognized for their superior hover performance, due to their large rotors, low disk loading, that generate high lift effectively. Yet, this advantage comes with significant trade-offs, especially during cruise flight. Issues like dissymmetry of lift, retreating blade stall, and low L/D make helicopters inefficient, limit their maximum speeds, resulting in reduced operational range and poor cruise performance.

In an effort to overcome these limitations, tilt-rotor and tilt-wing designs were developed, enabling aircraft to transition their propulsion systems from vertical to horizontal orientations. This allows the wings to generate lift during cruise; however, the propulsion system must perform dual roles: providing high thrust at low speeds for hover, and thrust at high speeds for cruise. This dual-purpose configuration compromises performance in both flight regimes. Since the proprotors are required to provide full lift and control during hover, their performance in high-speed wing-borne flight is significantly compromised, leading to excessive power consumption and increased drag. This results in low L/D and poor performance during cruise. Additionally, the interaction between the proprotors and the wings can cause flow disturbances, such as impingement effects, fountain flow, and flow separation, which further degrade hover efficiency.

Other hybrid VTOL solutions, such as lift +cruise aircraft (e.g. Wisk Aero Cora Gen.5) and compound helicopters (e.g. Piasecki PA-890 concept), attempt to enhance efficiency by using separate propulsion systems for lift and cruise. However, these systems introduce additional weight, complexity, inefficiency and drag. The unused propulsion system in each flight mode reduces the overall performance, leading to challenges with excessive weight, higher power consumption, and often poor control authority, especially during transitions between flight modes.

The lip-wing concept, as described in previous patents by the author, has demonstrated its potential to improve hover efficiency by integrating aerodynamic wing surfaces with the propulsion system to enhance hover lift, with less compromise on cruise performance. However, traditional lip-wing designs often increase wing wetted surface area due to their wing structure, resulting in additional drag and weight penalties.

The present invention improves upon the lip-wing concept by introducing a novel lip-wing blended body design. This design enhances hover performance by increasing the surface area of the lip-wing, seamlessly integrating a portion of the fuselage within a blended wing body configuration. This integration optimizes aerodynamic interaction with the thrust inflow region, resulting in greater efficiency during hover and improved performance in level flight. The novel blended-lip-wing quad aircraft design also improves control and provides redundancy, while integrated thrust vectoring with classic control surfaces simplifies and enhances control across hover, transition, and cruise flight. This configuration offers a more efficient and versatile solution for VTOL applications compared to traditional designs.

### SUMMARY OF THE INVENTION

The invention introduces a V/STOL aircraft featuring a lip-wing blended-body design that enhances hover performance, control, reduces weight and drag, and optimizes propulsion, ensuring cruise superior stability, efficiency, and overall built-in redundancy.

The aircraft employs a canard wing configuration with thrust devices—such as propellers, rotors, or fans—positioned near each wing and powered by motors, engines, or other sources.

A key innovation is the improved blended-lip-wing design, integrated into each wing. As disclosed in prior patents by the inventor, the lip-wing is a specialized wing section that augments hover thrust by capturing, containing, and directing airflow toward the propulsion device's inflow region. This enhanced version expands the lip-wing surface by incorporating part of the fuselage into the wing structure, forming a blended-wing-body configuration. This modification increases hover thrust augmentation while reducing the depth of the lip-wing channel, thereby minimizing wet surface area, drag, and weight.

By generating significant lift, the improved blended-lip-wing reduces reliance on thrust for hover, while also straightening and accelerating inflow to enable propulsion optimizations for forward flight. This enhances cruise efficiency while maintaining excellent hover and low-speed performance.

The thrust-providing device includes an aerodynamically shaped support structure that houses its components and functions as a control surface. Its movement also enables vectored thrust, improving hover maneuverability and low-speed control. These integrated thrust-vectoring aerodynamic surfaces, termed Vectored Control Surfaces (VCS), ensure superior stability and maneuverability across all flight phases.

A coupling and adjustment mechanism allows precise dynamic positioning of the propulsion device's inflow region relative to the blended-lip-wing. This functionality enhances hover lift augmentation, facilitates vectored thrust for improved hover control, and integrates conventional aerodynamic control, simplifying the overall control system.

As a result, the aircraft achieves smooth and efficient transitions between hover, low-speed, and high-speed flight while maintaining exceptional control authority and stability.

A sophisticated control system processes pilot and sensor inputs to provide precise yaw, roll, and pitch control. It independently adjusts each coupling, mechanism, and thrust device, enabling differential, symmetrical, or combined adjustments for optimal stability and maneuverability. This integrated system enhances safety and resilience across all flight phases and ensures redundancy.

This novel aircraft configuration achieves an optimal balance of hover efficiency, cruise performance, flight stability and redundancy, making it an ideal platform for next-generation V/STOL operations in military, commercial, and emergency response applications.

### BRIEF DESCRIPTION OF DRAWINGS

FIG. 1—Perspective view of the quad blended-lip-wing aircraft in hover mode.

FIG. 1A—Enlarged perspective view of the blended-lip-wing in hover showing airflow.

FIG. 2—Front view of the quad blended-lip-wing aircraft in hover mode.

FIG. 3—Side view of the quad blended-lip-wing aircraft in hover mode.

FIG. 4—Top view of the quad blended-lip-wing aircraft in hover mode.

FIG. 5—Perspective view of the quad blended-lip-wing aircraft in level flight mode.

FIG. 5A—Enlarged perspective view showing the coupling and adjustment mechanism through virtual cuts.

FIG. 6—Front view of the quad blended-lip-wing aircraft in level flight mode.

FIG. 7—Side view of the quad blended-lip-wing aircraft in level flight mode.

FIG. 8—Top view of the quad blended-lip-wing aircraft in level flight mode.

FIG. 9—Schematic diagram of the flight control system

### REFERENCE ITEMS LIST

10—fuselage with a blended wing body configuration
11—canard pair of wings
12—main pair of wings
13—thrust-providing device
14—propulsion device
15—boundary to the airstream inflow region into the propulsion device
16—motor, or similar device to provide power to the propulsion device
17—a wing section as part of the blended-lip-wing
18—blended-lip-wing aerodynamic structure
19—vectored control surface (VCS) aerodynamically shaped support structure
20—a portion of the fuselage as part of the blended-lip-wing
21—tail
1A—enlarged perspective view
23—airstream
22—aircraft center of gravity
5A—enlarged perspective view
30—coupling and adjustment mechanism
31—bearings, joints or similar coupling devices
32—actuator controlling the pivoting or rotation
33—virtual cuts to show hidden elements
35—arrow indicating movement
40—control system
41—actuator drivers for each coupling and adjustment mechanism
42—differential algorithms
43—symmetrical algorithms
44—thrust control drivers for each thrust-providing device
45—output and input variables
46—pilot inputs
47—sensors
48—PID algorithms

### DETAILED DESCRIPTION OF THE INVENTION

### Overview

The present invention improves upon the author's previous lip-wing design, as disclosed in CA2859258C, U.S. Pat. No. 9,845,152B2, and EP2985220B1. It introduces an advanced vertical and short takeoff and landing (V/STOL) aircraft featuring a novel lip-wing blended-body configuration (blended-lip-wing), which enhances aerodynamic efficiency, hover lift augmentation, control and flight stability. This advanced design optimizes both hover and forward flight performance, enabling seamless transitions between flight modes while maintaining superior control and efficiency.

### Theory of Operation

In the disk actuator theory, a thin disk serves as a simplified representation of a conventional open propeller, with thrust generated through the pressure differentials across the disk, resulting from forced air movement driven by the power supplied to the system. The theory highlights that under static conditions, such as hover, the slipstream behind the disk contracts, and its velocity is approximately twice the velocity of the air passing through the disk. This occurs due to a pressure drop behind the disk, as the slipstream returns to atmospheric pressure, which in turn reduces the efficiency of the open propeller in such conditions.

Among other enhancements, the present invention mitigates this efficiency loss by reducing the pressure aft of the disk-ideally to atmospheric pressure-through a controlled reduction of pressure in front of the disk. This is achieved through the use of aerodynamic surfaces that capture, contain, and direct airflow toward the disk, thereby straightening and increasing the velocity of the incoming airstream, reducing the pressure in the inflow region, and consequently the pressure aft of the disk.

This principle is conceptually similar to ducted or shrouded propellers designed for static conditions and fan-in-wing configurations. However, ducted propellers used in VTOL operations face inherent limitations, particularly the inability to adapt the intake geometry during high-speed cruise flight, which results in high drag. Additionally, ducted propellers and fan-in-wing configurations experience instability during transition due to reverse flow occurring in the aft region of the duct lip or wing. Moreover, fan-in-wing configurations are often too short to function effectively as ducted fans, and do not contribute to propulsion during wing-borne flight, leading to reduced efficiency, complexity and unnecessary dead weight.

The present invention overcomes these challenges through the innovative use of a novel blended-lip-wing configuration, which allows for dynamic adjustment of the geometry and prevents reverse flow during transition by omitting aft surfaces. The blended-lip-wing configuration improves control over the airflow, resulting in a more stable and efficient system during both hover and transition phases of flight.

Another key principle of the invention is that the propulsion system accelerates airflow over the blended-lip-wing, reducing pressure and enhancing lift. This increased airflow over the top surfaces improves circulation around the wing, allowing the aircraft to operate at a higher angle of attack. This not only boosts lift but also delays stall-particularly beneficial during the critical transition from hover to forward flight. Additionally, the accelerated airflow helps prevent boundary layer separation, which is a major contributor to stall and control loss at low speeds.

This principle is similar to the Custer Channel Wing, which uses accelerated airflow to enhance lift and delay stall. However, the Custer Channel Wing has several limitations. The thrust and lift forces act at right angles to each other, making it inefficient for VTOL operations. Additionally, uneven blade loading and vibration negatively impact performance, while power loss directly leads to stall and loss of lift.

In contrast, the blended-lip-wing design addresses these issues by optimizing the alignment and magnitude of thrust and lift, maximizing hover performance. By repositioning the thrust and moving the propulsor away from the wing's surface, the blended-lip-wing equalizes blade loading, reduces vibration and noise, and the proposed quad blended-lip-wing aircraft incorporates inherent redundancy for enhanced safety.

### Structural Design and Functionality

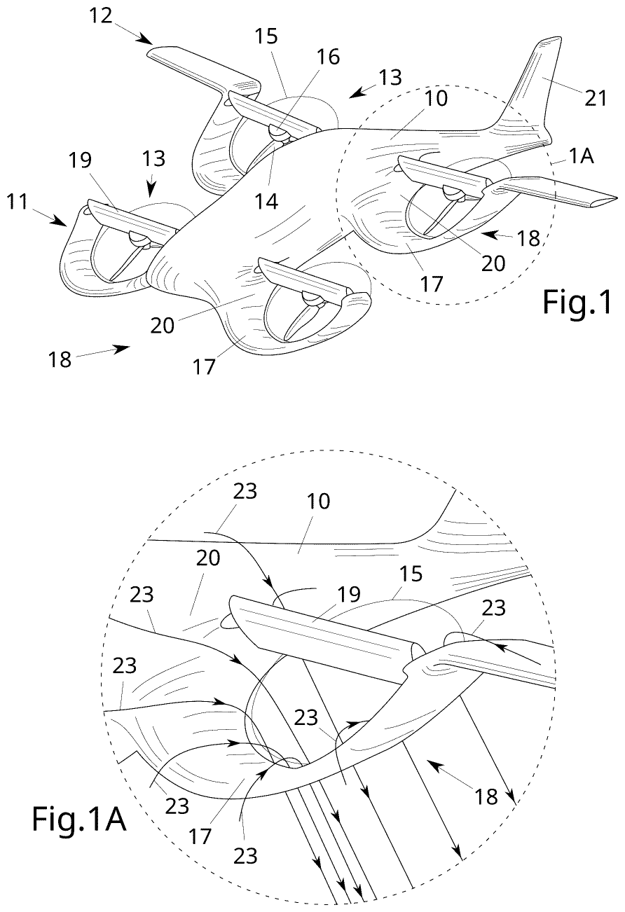

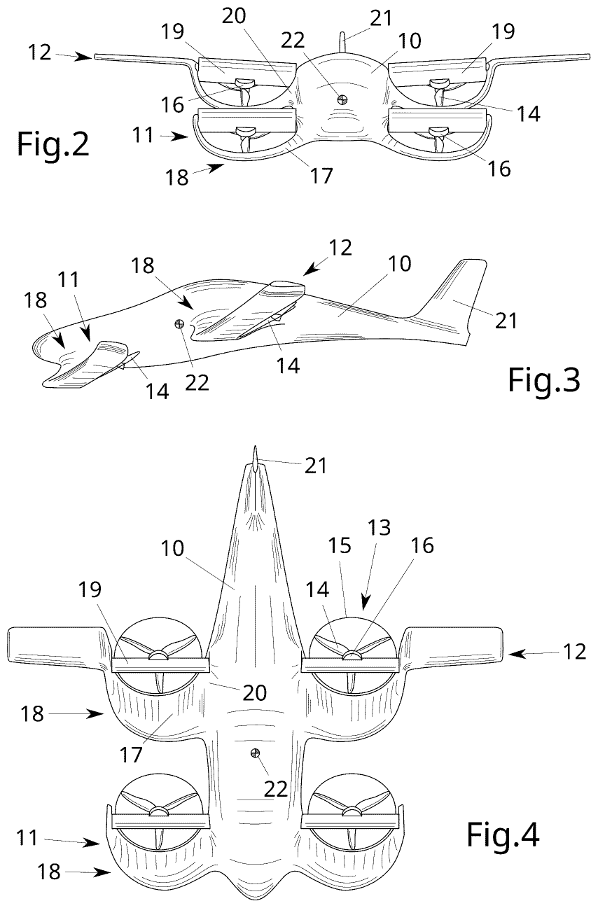

FIG. 1, FIG. 2, FIG. 3 and FIG. 4 illustrate a preferred embodiment of the aircraft, featuring a quad lip-wing blended-body design, in a Vertical/Short Takeoff and Landing (V/STOL) configuration. The aircraft features a fuselage 10 with a blended wing body design, optimizing aerodynamics and structural efficiency. It incorporates a first pair of wings 11, commonly referred to as canard wings, positioned forward of the center of gravity 22, and a second pair of wings 12, known as main wings, positioned aft of the center of gravity 22. Each wing from both pairs is positioned on opposite sides of the fuselage 10, ensuring stability and balance in all flight phases.

Each wing integrates a thrust-providing device 13, which include a propulsion device 14 such as a propeller, rotor, fan, or other air-accelerating mechanisms. The propulsion device 14 is powered by a motor 16, or internal combustion engine, or other power sources. The propulsion system also includes an inflow region delimited by a boundary 15, which defines the airflow entering the propulsion device 14.

To further enhance stability and control in all flight phases, the aircraft is equipped with a tail 21, which provides directional stability, particularly during forward flight. A landing gear is intentionally not depicted in the figures to maintain clarity and focus on the significant aerodynamic and structural elements of the aircraft.

An enlarged perspective view is illustrated in FIG. 1A, showing the airstream 23 flowing around elements of the aircraft. The motor 16 and the propeller 14 are not depicted for a cleaner view. A key enhancement features an aerodynamic structure 18 comprising a wing section 17 and a portion of the fuselage 20 as part of the blended wing body. This aerodynamic structure 18 is specifically engineered to capture, contain, accelerate and direct the airstream 23 toward the inflow region delimited by boundary 15 of the propulsion device 14, increasing the speed of the airstream 23 while reducing air pressure over the wing section 17 and fuselage portion 20. The aerodynamic structure 18 includes a channel with a carefully designed curvature, ensuring that the upper surface of the aerodynamic structure 18 aerodynamically matches the inflow region boundary 15, optimizing the smooth flow of air into the inflow region and minimizing aerodynamic losses, turbulence, and flow separation. The aerodynamic structure 18 also confines the airstream 23 as it flows towards the boundary 15, preventing propulsion device 14 blade tip losses and blocking atmospheric pressure ingress. By tailoring the curvature, airfoil shapes, contour, and orientation of the aerodynamic surfaces in relation to the propulsion device 14, the design is engineered to maximize lift augmentation and enhance low-speed flight performance, thereby improving the efficiency of the V/STOL configuration.

The aerodynamic structure 18 increases the surface area affected by the accelerated air, low-pressure, of the airstream 23, resulting in a significantly larger lifting surface and enhanced hover lift compared to the original lip-wing design. Moreover, a traditional blended wing-body configuration inherently features a curvature, enabling the novel aerodynamic structure 18 to require a shallower channel depth than the original lip-wing. This reduction in channel depth decreases the total wetted surface area and weight, thereby reducing drag and improving the overall efficiency of the aircraft.

Positioning of the inflow region boundary 15 substantially adjacent to the aerodynamic structure 18, maximizes airflow and aligns the thrust of the propulsion device 14 with the lift generated by the aerodynamic structure 18. At that position, the orientation of the propulsion device 14 and shape of the aerodynamic structure 18 are predetermined to optimize hover thrust augmentation, thereby enhancing the efficiency of V/STOL operations. For the aforementioned reasons the aerodynamic structure 18 is thermed blended-lip-wing.

The thrust-providing device 13 includes an aerodynamically shaped support structure 19 that houses the motor 16 and other components while also serving as a conventional control surface. Since the movement of the support structure 19 enables vectored thrust and integrates conventional aerodynamic control, the aerodynamically shaped support structure 19 is termed the Vectored Control Surface (VCS). It simplifies control, enhances hover maneuverability, improves transition stability, and optimizes cruise control, making it a versatile component of the aircraft's design.

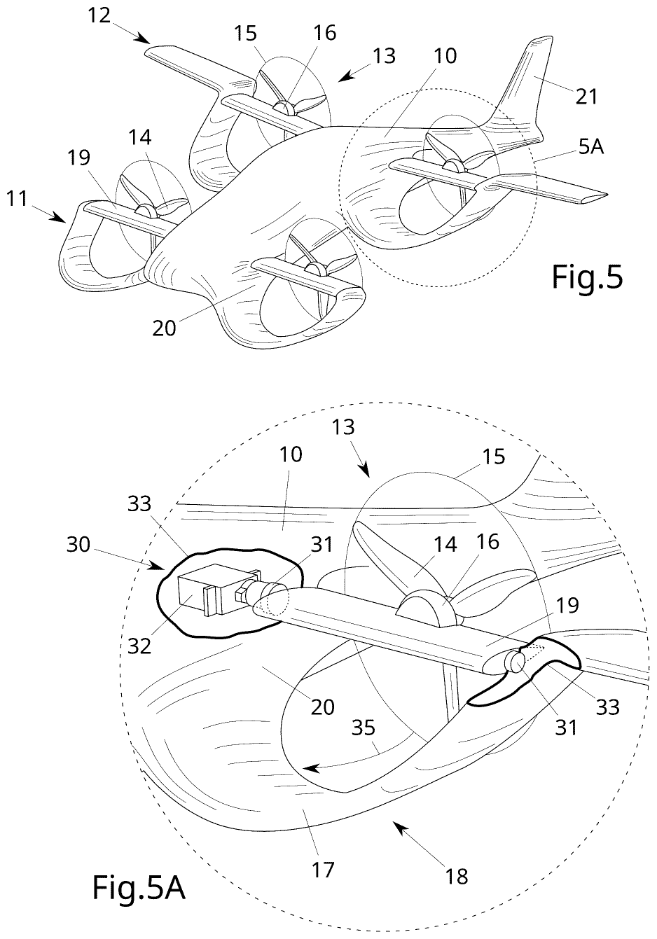

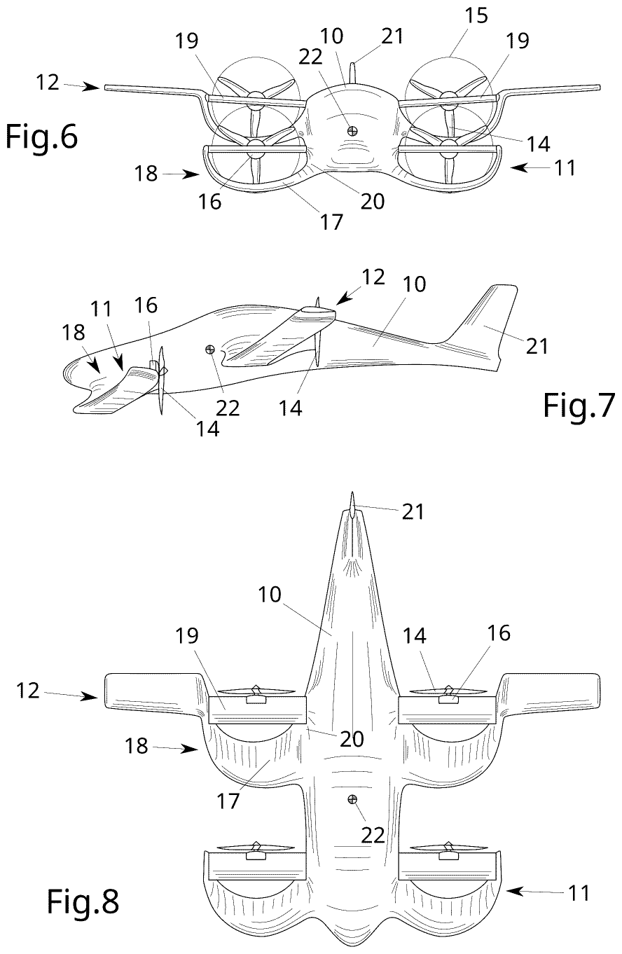

FIG. 5, FIG. 6, FIG. 7, and FIG. 8 illustrate the aircraft in cruise, wing-borne flight mode, where the canard wings 11 and the main wings 12, including the wing sections 17, function as conventional lifting surfaces. The vectored control surfaces 19 are positioned mainly horizontally, aligning the propulsion devices 14 for forward thrust while simultaneously providing both conventional and vectored control, enhancing control authority during level flight.

FIG. 5A illustrates a coupling and adjustment mechanism 30 designed to modify the position and orientation of the thrust-providing device 13 and its components, including the motor 16, propulsion device 14, inflow region boundary 15, and vectored control surfaces 19.

The coupling and adjustment mechanism 30 is shown through virtual cuts 33, revealing its components, including bearings, joints, or similar pivoting devices 31 and an actuator 32 that enables precise controlled rotation or repositioning.

Also shown, using arrow 35, is the movement of the inflow region boundary 15 toward the wing section 17 as the aircraft transitions to hover mode, optimizing airflow for enhanced lift augmentation.

As the aerodynamic structure 18 contributes to lift generation during hover and low-speed flight, the thrust-providing device 13 is no longer solely responsible for generating full lift during V/STOL phases. Additionally, exposure to an increased velocity and a more streamlined airstream 23 enables the design of the thrust-providing device 13 to be optimized for high-speed, increasing its effectiveness in level flight, thereby enhancing cruise performance. Unlike prior art tilt-rotor and tilt-wing VTOL designs, which require propulsion systems to provide full thrust in hover-compromising cruise efficiency-this configuration allows for a more aerodynamically efficient and speed-optimized propulsion system, enhancing overall aircraft performance across all flight phases.

Moving the inflow region boundary 15 away from its adjacent position to the aerodynamic structure 18 drastically reduces the lift generated by the aerodynamic structure 18, resulting in a significant change in both the magnitude and direction of the total force produced by the aerodynamic structure 18 and thrust-providing device 13 systems. This enables a substantial augmentation of control moments in hover, achieved through small adjustments of the coupling and adjustment mechanism 30 that moves the inflow region boundary 15 around adjacent position to the aerodynamic structure 18. These adjustments, made differentially or symmetrically across each pair of wings, enhance all control moments—yaw, pitch, and roll—providing improved maneuverability and control in hover and slow speeds.

With the aerodynamic structure 18 configured to generate controlled variable lift, as aforementioned, and the added capability to control thrust vectoring and aerodynamic forces using the vectored control surfaces 19, this system performs significantly better during transition than prior art, such as lift+cruise configurations. These traditional designs are often plagued by control issues and lift loss due to aerodynamic interference. In contrast, the integrated design here eliminates such problems, ensuring smoother transitions and maintaining consistent lift and control throughout the entire flight envelope.

The novel blended-lip-wing aircraft offers significant advantages in both hover and high-speed cruise flight. By integrating a blended wing body with a lip-wing configuration, the aircraft achieves enhanced aerodynamic efficiency, optimizing hover lift, reducing drag and improving lift-to-drag (L/D) ratios while enabling more effective thrust generation across different flight regimes. During hover, the blended-lip-wing contributes to thrust augmentation, reducing power consumption during the most energy-intensive phase of flight. It also improves transition performance by enhancing control authority, increasing lift, and mitigating stall effects. In cruise, the configuration minimizes drag and optimizes propulsion efficiency, reducing the aerodynamic penalties typically associated with conventional VTOL designs.

The blended-lip-wing aircraft enables a seamless transition to wing-borne flight. Unlike traditional wing designs, which require high-lift devices such as flaps and slats, the blended-lip-wing naturally generates sufficient lift at low speeds without additional mechanical complexity. This eliminates the need for movable high-lift surfaces, reducing weight and maintenance requirements. As a result, the wings can be smaller and optimized for high-speed cruise, minimizing drag and further improving overall efficiency. These aerodynamic improvements lead to higher cruise speeds, increased endurance, and superior energy efficiency, making the aircraft more versatile and capable of sustained high-performance operations across both vertical and horizontal flight modes.

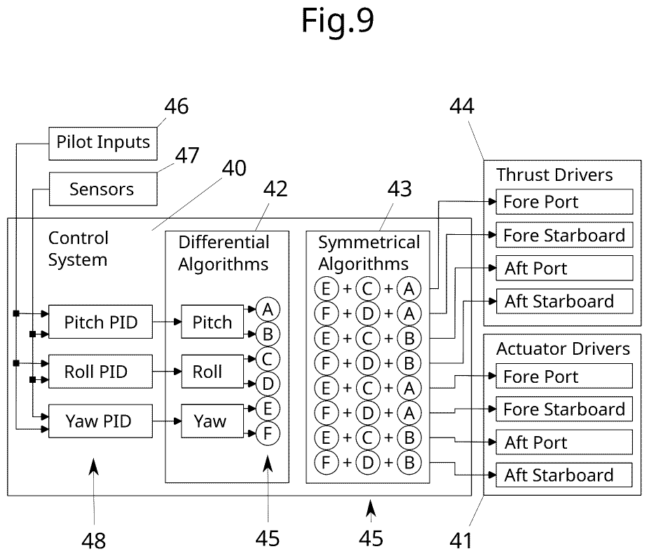

FIG. 9 illustrates a sophisticated control system 40 that processes inputs from the pilot 46 and sensors 47 using PID algorithms 48. It incorporates differential 42 and symmetrical 43 control algorithms and further processes input-output variables 45 for refined adjustments. The control system 40 individually regulates each coupling and adjustment mechanism 30 via actuator drivers 41, controlling each actuator 32 independently. Additionally, it provides independent thrust control for each thrust-providing device 13 through the thrust drivers 44, enabling precise yaw, roll, and pitch control.

The control system 40 ensures combined adjustments, optimizing stability and maneuverability across all flight phases. Redundancy is built in by monitoring the thrust-providing device 13 or its corresponding coupling and adjustment mechanism 30 for failures. If a failure occurs, the control algorithms are adjusted to compensate. The system can tolerate the failure of up to two diagonally opposed thrust-providing devices 13 and/or their associated coupling mechanisms 30 while maintaining full control in hover. This is achieved by ensuring that the thrust from the remaining operational devices has a resultant vector that passes through the center of gravity 22. In level flight, redundancy is provided through the independent adjustment of thrust and aerodynamic control, allowing the aircraft to maintain stability and control even in the event of partial system failures. In the event of a total power loss, the aircraft can continue to fly and execute a controlled landing like a conventional glider.

By offering redundant, integrated, and comprehensive control, the control system 40 significantly enhances safety and operational resilience. This ensures seamless transitions and precise control throughout each phase of flight, providing reliable performance even under varied conditions. The aircraft remains highly responsive and stable, regardless of system failures or shifting flight dynamics.

### Alternative Embodiment

In some embodiments, a single pair of wings combined with a blended body may be responsible for producing the results claimed by the invention, such as improved lift augmentation during hover, augmented control, optimized aerodynamics for enhanced forward flight efficiency, and seamless transitions between flight modes. This configuration leverages the unique integration of the blended lip-wing body and thrust vectoring capabilities, ensuring that even with a reduced number of wings, the aircraft can achieve superior stability, maneuverability, and control throughout all flight phases. The combination of aerodynamic enhancements and control system sophistication ensures that these configurations perform comparably to more complex designs, offering significant advantages in terms of simplicity, weight reduction, and operational efficiency.

### Conclusion

In conclusion, the novel lip-wing blended-body design presented herein offers a significant advancement over prior art in V/STOL aircraft configurations. Through the integration of the blended-lip-wing, enhanced aerodynamics, and innovative integrated thrust vectoring capabilities, the invention provides substantial improvements in both hover and forward flight performance. The inclusion of a sophisticated control system further ensures superior stability, maneuverability, and redundancy, offering greater safety and operational flexibility. This design not only addresses existing challenges in VTOL aircraft but also sets the foundation for more efficient, reliable, and versatile aircraft capable of meeting the demands of modern aerospace applications. As such, this invention represents a transformative step forward in the development of advanced V/STOL aircraft, with potential applications spanning commercial, military, and industrial sectors.

1) An aircraft comprising:
a) a fuselage with a blended wing-body configuration;
b) at least one pair of wings positioned on opposite sides of the fuselage, each wing comprising:
i) at least one thrust-providing device, the thrust-providing device comprising:
a propulsion device comprising a propeller, rotor, fan, or equivalent air-accelerating mechanism, the propulsion device including an inflow region; and
a power source configured to drive the propulsion device, the power source comprising an electric motor, internal combustion engine, or other device configured to supply power;
ii) a coupling and adjustment mechanism, the coupling and adjustment mechanism comprising at least one bearing, joint, or similar pivoting device, and an actuator configured to provide controlled rotation or repositioning, the coupling and adjustment mechanism configured to modify the position and orientation of the thrust-providing device; and
iii) an aerodynamic structure comprising a section of the wing and a portion of the fuselage, the aerodynamic structure comprising a channel having a predetermined curvature configured to aerodynamically conform to the inflow region to capture, accelerate, direct, and enhance airflow toward the inflow region, wherein the coupling and adjustment mechanism is operable to position the thrust-providing device to a predetermined orientation, such that the inflow region is substantially adjacent to the aerodynamic structure, and the predetermined orientation of the thrust-providing device and the predetermined curvature of the aerodynamic structure are cooperatively configured to optimize thrust augmentation during hover and low-speed flight.

2) The aircraft of claim 1, wherein the thrust-providing device includes an aerodynamically shaped support structure, and wherein the coupling and adjustment mechanism is configured to adjust the support structure for both aerodynamic control and vectored thrust, thereby facilitating integrated control for level flight, low-speed, and hover operations.

3) The aircraft of claim 1, further comprising a control system, the control system configured to adjust each coupling and adjustment mechanism differentially, symmetrically, or in any combination thereof to enhance at least one of yaw, roll, and pitch control.

4) (canceled)

5) (canceled)

6) (canceled)

7) The aircraft of claim 3, wherein the aircraft has a center of gravity, and wherein the at least one pair of wings comprises a first pair of wings positioned forward of the center of gravity, and a second pair of wings positioned aft of the center of gravity.

8) The aircraft of claim 7, wherein the control system further configured to provide individual thrust control for each thrust-providing device, thereby enabling redundant, integrated, and comprehensive control during all phases of flight.

9) A method for augmenting performance and enhancing control authority of an aircraft having a blended wing-body fuselage and at least one pair of wings positioned on opposite sides of the aircraft, comprising the steps of:
a) providing each wing with:
i) at least one thrust-providing device, the thrust-providing device comprising:
a propulsion device, the propulsion device comprising a propeller, rotor, fan, or other air-accelerating mechanism, the propulsion device including an inflow region; and
a power source configured to drive the propulsion device, the power source comprising an electric motor, internal combustion engine, or other device configured to supply power;
ii) a coupling and adjustment mechanism, the coupling and adjustment mechanism comprising at least one bearing, joint, or similar pivoting device, and an actuator configured to provide controlled rotation or repositioning, the coupling and adjustment mechanism configured to modify the position and orientation of the thrust-providing device; and
iii) an aerodynamic structure comprising a section of the wing and a portion of the fuselage, the aerodynamic structure comprising a channel having a predetermined curvature configured to aerodynamically conform to the inflow region to capture, accelerate, direct, and enhance airflow toward the inflow region; wherein the coupling and adjustment mechanism is operable to position the thrust-providing device to a predetermined orientation, such that the inflow region is substantially adjacent to the aerodynamic structure, and the predetermined orientation of the thrust-providing device and the predetermined curvature of the aerodynamic structure are cooperatively configured to optimize hover thrust augmentation; and
b) providing a control system, configured to individually adjust each coupling and adjustment mechanism.

10) The method of claim 9, wherein the thrust-providing device includes an aerodynamically shaped support structure, and wherein the coupling and adjustment mechanism enables adjustment of the support structure for both aerodynamic control and vectored thrust, thereby facilitating integrated control for level flight, low-speed flight, and hover operations.

11) The method of claim 9, further comprising the step of adjusting each coupling and adjustment mechanism differentially, symmetrically, or in any combination thereof to enhance at least one of yaw, roll, and pitch control authority.

12) (canceled)

13) The method of claim 9, further comprising the step of adjusting the coupling and adjustment mechanism to adjust the position of the inflow region relative to the aerodynamic structure, thereby augmenting control moments in hover and at slow speeds.

14) The method of claim 9, wherein the aircraft has a center of gravity, and further comprising the steps of:
a) positioning a first pair of wings forward of the center of gravity; and
b) positioning a second pair of wings aft of the center of gravity,
wherein the at least one pair of wings comprises the first pair of wings and the second pair of wings.

15) The method of claim 14, further comprising the step of configuring the control system to provide individual thrust control for each thrust-providing device, thereby enabling redundant, integrated, and comprehensive control during all phases of flight.
